(19) United States
(12) Patent Application Publication
(10) Pub. No.: US 2004/0211371 A1
(43) Pub. Date: Oct. 28, 2004

(54) Device and method for securing a tether

(76) Inventors: Richard William Schofield, Ojai, CA (US); Joyce Walene Schofield, Ojai, CA (US)

Correspondence Address: Richard Schofield, 20787 Blackfoot Trail, Redding, CA, 96003, US

(21) Appl. No.: 10/421,142

(22) Filed: Apr. 23, 2003

(51) Int. Cl. A01K 1/08

(52) U.S. Cl. 119/772

(57) ABSTRACT

A device and method for securing a tether, such as a lead rope used to tie a horse, to a fixed object, such as a tie-rail. The load end of the tether, which is attached to the horse's halter, is looped one or more times over the tie-rail, and the invention secures the loose end of the tether to the load end of the tether. Adjustment of the device and method determines the tension or load at which the horse can pull out additional rope. The device can be easily applied and removed. Pulling down on the loose end of the lead rope releases the device quickly when needed.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates specifically to the securing of a lead rope as used to tether a horse or other animal. This invention also relates more generally to securing ropes, straps and other tethers used to anchor large items such as boats or equipment.

It is common practice to tether a horse to a hitching rail or tie-rail using a lead rope attached to the horse's halter. The most common type of lead rope is about ⅝ of an inch in diameter and about 8 to 10 feet long, and is made of synthetic or natural fiber. The typical hitching rail is made of metal water pipe, and is between 2.5 and 5 inches in diameter, or is made of wood with a circular or non-circular cross-section. The rider usually loops the lead rope one or more times around the hitching rail, and ties the loose end of the lead rope so that the horse cannot pull free. Typically, the loose end is tied to the halter end or “load end” of the lead rope using a slip knot, which is designed to provide a quick release function.

One problem with using a slip knot is that some people have difficulty tying it correctly. Another problem is that many horses can undo a slip knot by pulling on the loose end of the rope with their teeth. Another problem is that the knot often comes loose due to the motion of the lead rope caused by movement of the horse. Yet another problem is that the knot and lead rope often tangle to the point that the knot would not slip and release in an emergency situation.

The device and method of the present invention provide an alternative to this slip knot, and an alternative to any other means of securing a lead rope.

The desired elements of the present invention, as it applies to tying horses, are as follows:

It should work on most standard lead ropes

It should work on the majority of hitching rails

It should be simple to apply

It should be fast to apply

It should require no special skills to apply

It should be simple to remove

It should be fast to remove

It should provide a means for quick release under emergency circumstances

It should release more rope or give way if the horse exerts the requisite force

It should be adjustable in the force at which it will give way

It should be adjustable to the extent that it will not give way even under extreme force

It should be durable

It should be inexpensive to manufacture

It should be adjustable in the tethering length

It should be reusable

It should be reusable on various lead ropes

It should be adjustable to fit common variations in lead ropes

It should attach semi-permanently to the lead rope if desired

It should not be able to be unfastened easily by the horse

It should not work itself free when the horse moves around

It should withstand wetness and other environmental exposures

It should withstand chewing by the horse

The present invention and method provides all of these desired elements.

### BRIEF SUMMARY OF THE INVENTION

The present invention is a device and method for securing a tether rope to a tie-rail. First, the tether rope is looped one or more times over the tie-rail. Rather than securing the rope by the common method of tying a slip knot or other knot, the present invention is used to secure the loose end of the tether rope to the load end of the tether rope in such a fashion that is can be easily removed. Unlike a slip knot, the present invention allows the tether rope to slip through in a controlled fashion, so that if a horse, for example, pulls back with a prescribed force, more rope will pull over the tie-rail thereby lengthening the tether distance. The present invention can be removed in a similar method to undoing a slip knot, whereby the device releases if the loose end of the tether rope is pulled with sufficient force.

The preferred embodiment of the invention comprises a wide strap of fabric webbing, with two sets of hook-and-loop fasteners, positioned so that the device can be secured to both the load end and the loose end of the tether rope, accomplishing the desired elements listed in the background section.

### BRIEF DESCRIPTION OF THE DRAWINGS

FIG. 1 shows the invention tethering a horse to a tie rail.

FIG. 2 shows a schematic cross-section of a first embodiment of the invention.

FIG. 3 shows a schematic cross-section of a second embodiment of the invention.

FIG. 4 shows a schematic cross-section of a third embodiment of the invention.

FIG. 5 shows a schematic cross-section of a fourth and preferred embodiment of the invention.

FIG. 6 shows the first step in the method of using the present invention with the preferred embodiment of the invention.

FIG. 7 shows the second step in the method of using the present invention with the preferred embodiment of the invention.

FIG. 8 shows the third step in the method of using the present invention with the preferred embodiment of the invention.

FIG. 9 shows the fourth step in the method of using the present invention with the preferred embodiment of the invention.

FIG. 10 shows an alternate mode of adjustment of the preferred embodiment of the invention.

FIG. 11 shows a dimensioned orthographic projection of the preferred embodiment.

### DETAILED DESCRIPTION OF THE INVENTION

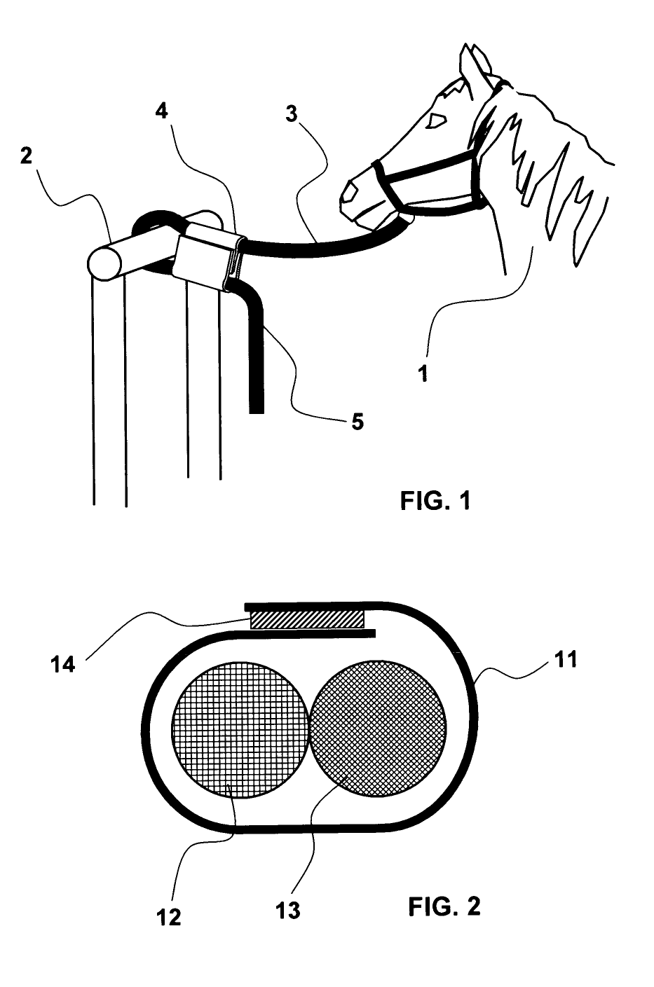

Referring to FIG. 1, the present invention provides a method and device for tethering a horse 1 or other animal or object to a hitching rail 2. The tether rope is looped over the hitching rail, with the load end 3 of the rope attached to the animal or object being tethered. The present invention 4 secures the loose end 5 of the tether rope to the load end 3, thereby securing the tether.

FIG. 2 shows a schematic cross-section of the invention 11 securing the load end 12 and loose end 13 of the tether rope. In this embodiment, the present invention is in the form of a strap or collar or cuff. As a strap, the invention might be made of leather, heavy fabric or woven webbing. As a collar or cuff, it might be made of flexible or semi-rigid materials such as sheet metal or plastic. In this embodiment, the two ends of the rope are secured in contact with each other by wrapping the strap or collar 11 around the two ropes, and securing it in place by means of a fastener 14, which might be a hook-and-loop fastener, a snap fastener, or any other fastener that can be easily secured and undone, and which will come undone under sufficient tension.

Referring to FIG. 1 and the embodiment in FIG. 2, if the horse 1 pulls back with a prescribed force, the load end of the tether rope 3 & 12 will pull through the device in one direction, and the loose end 5 & 13 will pull through in the opposite direction. The friction brought about by their contact with each other and their contact with the inner surface of the device will determine what level of force is required before slippage will occur. This slippage is a desirable feature of the present invention.

The present invention can be adjusted to control the amount of force that is required before rope will slip through the device. This force is referred to here as the “Threshold Slip Load”. Factors that affect the Threshold Slip Load include the coefficient of friction of the tie-rail, the coefficient of friction of the inner surface of the device, and the tightness with which the device 11 is applied. This last factor is adjustable by the operator.

In the example of tethering the horse, there are situations where it is desirable for the tether rope to pull free under minimal force, such as training a foal to be tethered, and there are situations where it is desirable for the tether rope to only pull free under extreme force, such as if the horse is startled and pulls back violently. The present invention is adjustable to the extent that it can meet these extremes by applying it loosely or tightly. In general, if the horse does pull with sufficient force to pull more rope through, it will usually stop pulling with such force before the entire rope pulls through, and will thereby still be tethered, albeit at a longer distance from the tie-rail. This is usually preferable to the horse not being able to pull back at all, which often results in a dangerous situation and can result in serious injuries.

In the embodiment of FIG. 2, the fastener 14 is sized and applied in such a fashion that it will yield and break open if the loose end of the rope 5 is pulled in a more-or-less perpendicular direction to the load end 3. This allows an operator to disengage the device and free the tethered horse quickly in an emergency.

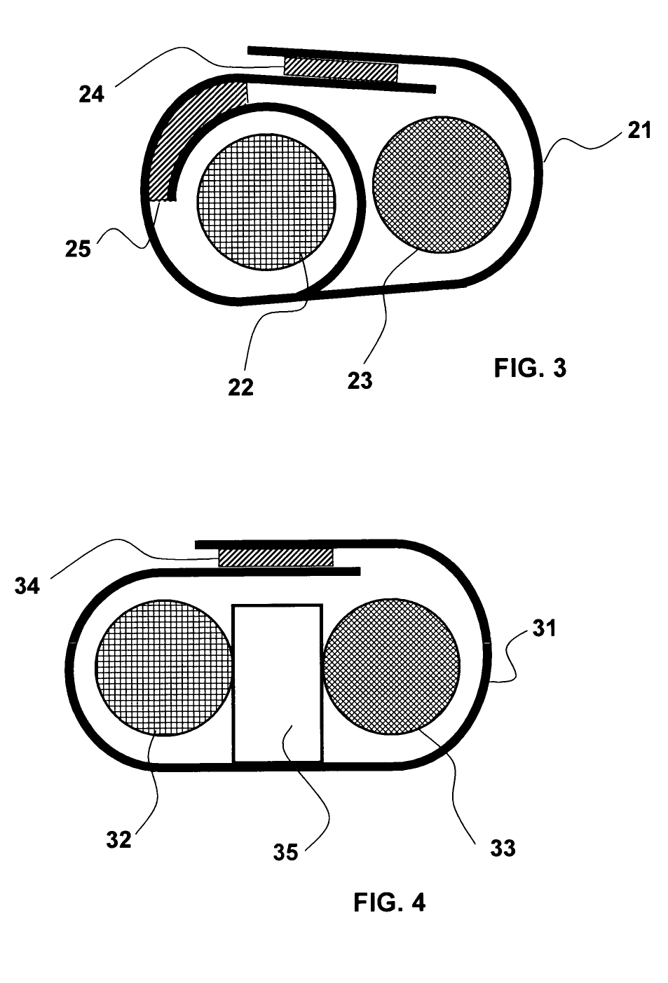

FIG. 3 shows a schematic cross-section of a second embodiment. In this variation, the device 21 attaches to the load end of the tether rope 22 by means of a first fastener 25, and then to the loose end 23 by means of a second fastener 24. This prevents the two ends of the rope from contacting each other. It also means that the tightness of the device, and hence the friction it imparts, can be adjusted separately for each section of rope. It also means that when the device is removed from the loose end 23, it may still remain attached to the load end 22, which can be convenient.

FIG. 4 shows a schematic cross-section of a third embodiment. In this variation, the device 31 attaches to the load end of the tether rope 32 and the loose end 33 by means of a single fastener 34. A spacer 35 prevents the two ends of the rope from contacting each other. Performance of the device was found to improve when the spacer distance was between about 50% and 100% of the tie-rail diameter. With smaller spacer distances or no spacer distance, the device had too high a tendency to disengage when load was applied to the tether.

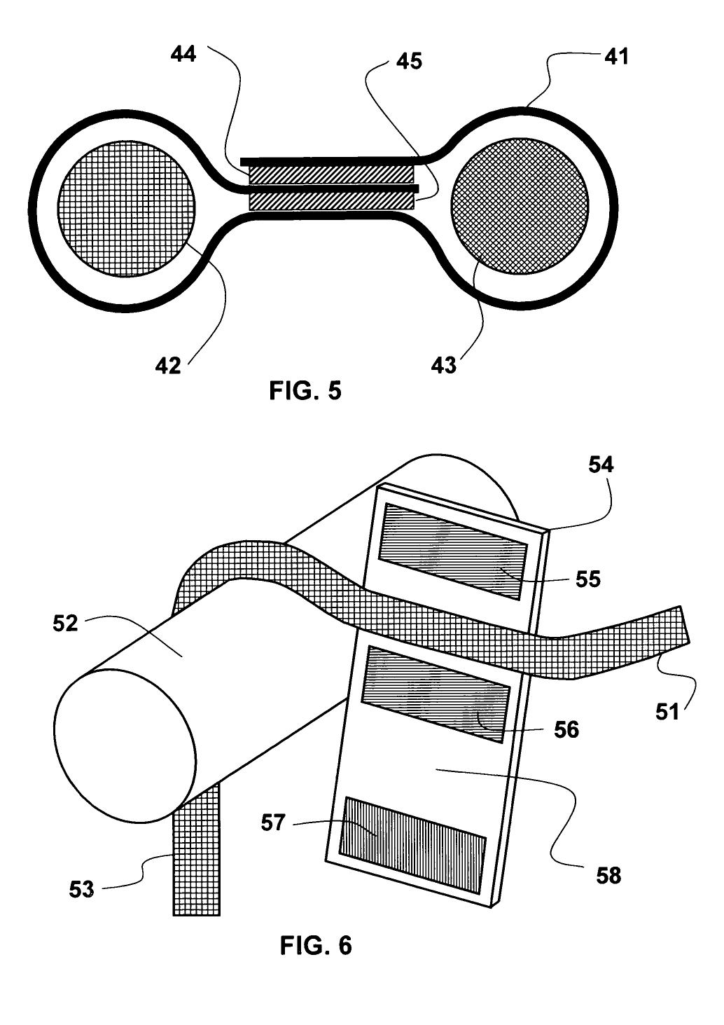

FIG. 5 shows a schematic cross-section of a fourth embodiment, which is a preferred embodiment of the present invention. In this variation, the device 41 attaches to the load end of the tether rope 42 by means of a first fastener 45, and then attached to the loose end 43 by means of a second fastener 44. The two fasteners fulfill the role of a spacer, separating the two sections of rope to an advantageous distance. The lose end of the rope 43 can be released by opening the second fastener 44, while still leaving the device attached to the load end of the tether rope 42. Also, the tightness can be controlled independently for each section of rope, providing broad adjustment of the friction on the two sections of rope.

FIG. 6 shows a schematic of the first step in the method of using the preferred embodiment of the device. This embodiment utilizes hook-and-loop fasteners (although other fasteners could be employed) attached to a wide strap of woven webbing, which provides a good balance between stiffness and flexibility. The tether rope 51 is draped over the tie-rail 52, leaving the loose end 53 hanging down. The device 54 is aligned so that a hook-section 55 and a loop-section 56 of the first fastener fall either side of the load end of the tether rope 51. Also shown is the loop-section of the second fastener 57, which will be utilized in a subsequent step. Note, in this embodiment, it is not critical which half of the hook-and-loop fastener occupies which position.

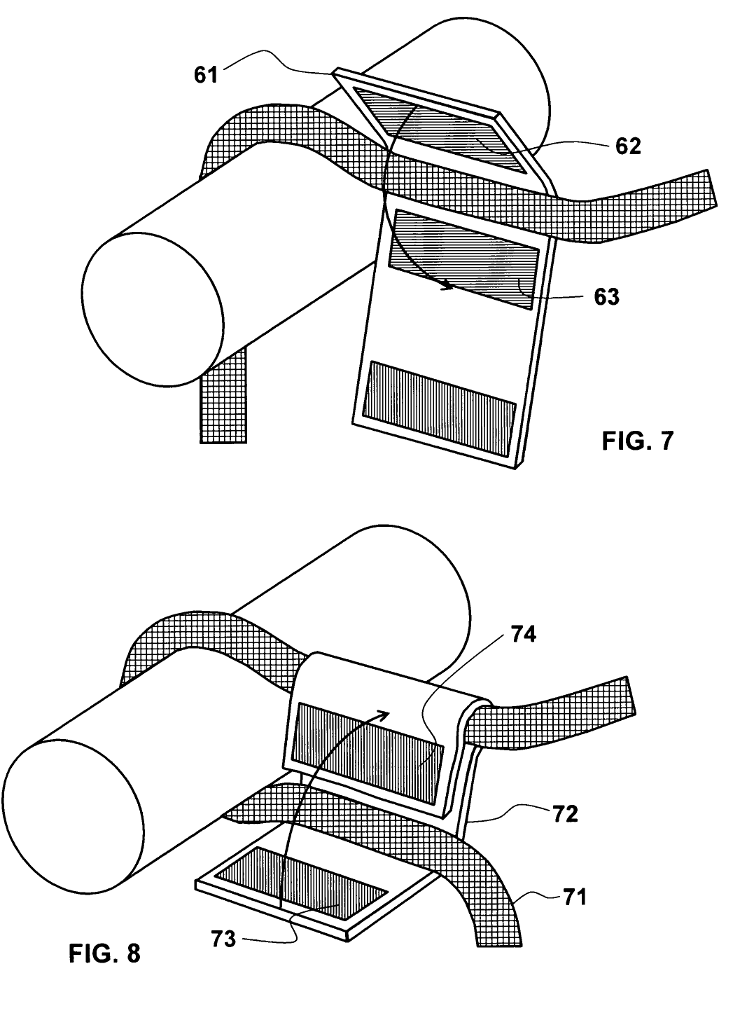

FIG. 7 shows a schematic of the second step in the method of using the preferred embodiment of the device. The woven webbing strap 61 is bent over the tether rope, bringing the hook 62 and loop 63 portions of the first fastener into contact, thereby attaching the device to the load end of the tether rope.

FIG. 8 shows a schematic of the third step in the method of using the preferred embodiment of the device. The loose end of the tether rope 71 is passed across the bottom section of the device, falling between the loop section 73 and the hook section 74 of the second fastener. Note, the hook section 74 was on the back of the device, and became visible when step two (see FIG. 7) was completed. The second fastener (73 and 74) is fastened, securing the loose end of the tether rope 71 within the device.

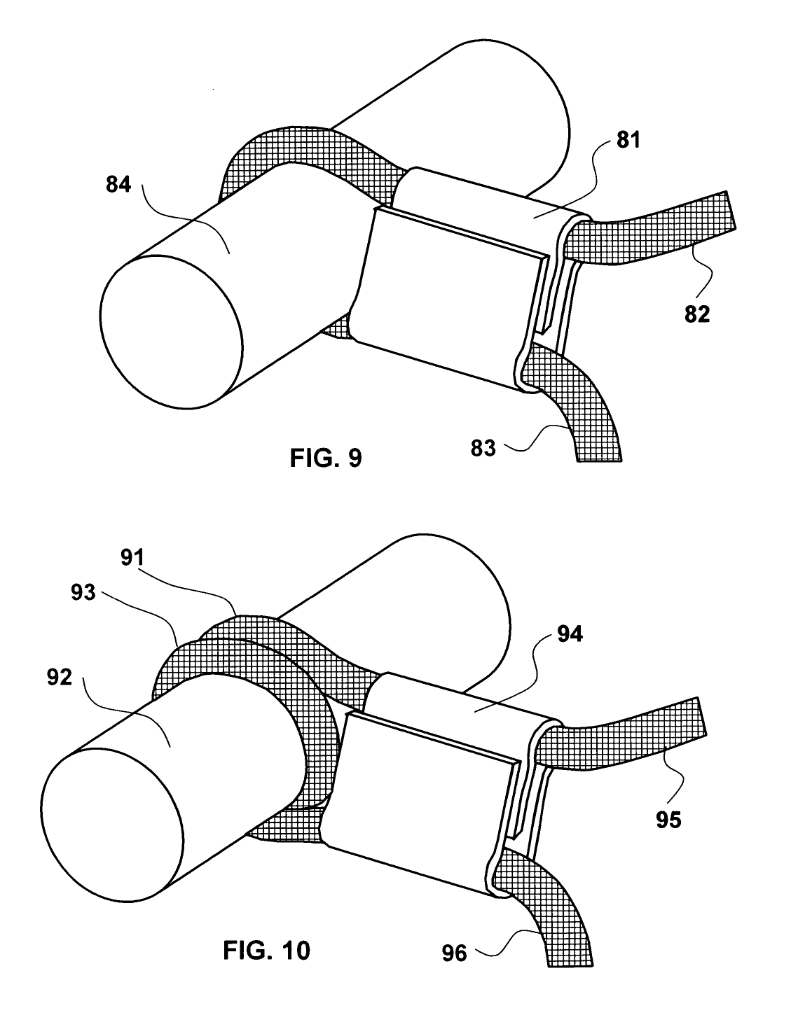

FIG. 9 shows a schematic of the preferred embodiment of the device in its final functional position. In its normal operation, the device 81 would be pushed up against (or close to) the tie-rail 84. When load is applied to the load end of the tether rope 82, most of the force of that load is carried by the tie-rail 84. The device simply controls slippage of the loose end 83 of the rope, dictating how much force is required to make more rope slip over the tie-rail 84.

If the horse (or other object or animal being tethered) applies sufficient force to cause the loose end of the tether rope 83 to slip through the device 81, then more rope will slip over the tie-rail and feed through the device, lengthening the tether distance. When the load is reduced or ceased, the slippage will stop, and the horse will remain tethered.

One feature of the present invention is that it can be released quickly in an emergency. If there is no load on the load end of the tether rope 82, the device can easily be unfastened by opening the second hook-and-loop fastener. If there is load on the load end of the tether rope 82, the device can easily be unfastened by pulling down or sideways (or generally in a direction more-or-less perpendicular to the load on the load end of the rope). This action causes the second fastener to open under the sideways force, thereby releasing the device.

Once the device has been released, it can be left attached to the load end of the tether rope for later use, and the second fastener can be closed (without wrapping around the loose end of the rope) to protect the hook-and-loop fastener from exposure to dirt and lint. Alternately, the device can be removed from the tether rope for use elsewhere or for storage.

In one enhancement of the preferred embodiment (and other embodiments), the friction produced between the device and the loose end of the tether rope 83 is increased by lining the device with a high-friction lining. This lining is applied to the region identified in FIG. 6 as 58. In one exemplary design based on the preferred embodiment, where the device is made of woven webbing (such as polypropylene), the friction contact region 58 is lined with leather, wherein a thin patch of leather is stitched to the surface of the device. Other potential methods of increasing friction include the attachment of other higher-friction materials or the painting or coating of the webbing surface with suitable materials, which may result in surface roughness, for example.

One advantage of applying a higher-friction surface in the friction contact region 58 is that the friction against the loose end of the tether rope 83 becomes greater than the friction against the load end of the tether rope 82. This means that when load is applied, and the rope slips through the device, the higher force imparted by the loose end of the rope 83 pulls the device up against the tie-rail, where it is intended to remain. If the friction is higher on the load end of the rope 82 than on the loose end 83, the device will stay in a fixed position on the load end of the tether rope, and will be pulled away from the tie-rail, thereby being removed from its intended position.

The present invention is adjustable in the force or load that is required before slippage will occur. There are two primary factors that influence this Threshold Slip Load. The first is the friction between the loose end of the rope 83 and the device 81. The second is the friction between the rope and the tie-rail 84.

The friction between the loose end of the rope 83 and the device 81 in turn depends on two factors. Firstly, it depends on the coefficient of friction between the rope and the inner surface of the device in the friction contact region 58. This provides a design variable, and the preferred embodiment is sized and has materials of construction that optimize this friction coefficient. For example, superior results have been obtained (for use with standard cotton and nylon lead ropes as used for horses) by stitching a three-inch by one-half-inch strip of suede leather to the center of the friction contact region 58. Secondly, the friction between the loose end of the rope 83 and the device 81 depends on how tightly the second fastener is applied. Hook-and-loop fasteners provide a good level of adjustability in this respect. This provides an operating variable for the device, and an operator can easily adjust and readjust the device in the field until the desired Threshold Slip Load has been achieved.

The friction coefficient between the rope and the tie-rail 84 is normally fixed, being a function of the tie-rail surface material and the tether rope material. The present invention, however, allows control of this friction component by allowing the tether rope to be looped more than one time over the tie-rail, as shown in FIG. 10. In this example, the rope is looped once 91 over the tie-rail 92, and then a second time 93. The device 94 is then secured by the usual method. When a load is applied to the load end of the tether rope 95, the increased friction of the double loop counterbalances a larger amount of the force, and so the residual force trying to pull the loose end 96 through the device is diminished. The result is that the Threshold Slip Load is significantly increased. If an even greater Threshold Slip Load is desired, the rope can be looped three or more times over the tie-rail.

The combined adjustments of 1) the number of loops over the tie-rail, and 2) the tightness of fastening the device, provide broad variability of the Threshold Slip Load. This is explained for a series of examples of tethering horses using a standard lead rope and a 3.5-inch diameter steel pipe tie-rail.

### EXAMPLE 1

A foal in training was tethered with one loop, and with the device applied loosely. The foal remained tethered as it moved around with normal random movement. When the foal pulled back, the device allowed more rope to slip through. This prevented the foal from feeling trapped. The operator periodically re-tethered the foal, shortening the tether distance after each episode of pulling back. With time, the device was secured more and more tightly, making the foal pull harder to gain more rope. This was continued until the foal was accustomed to being tied, thereby completing its tether training

### EXAMPLE 2

A lesson horse was tethered with two loops, and with the device applied securely. This prevented the horse from pulling through more rope in its attempts to reach grass or wander off. Numerous riding students who were not skilled at tying knots were able to easily tether and un-tether the horse using the device.

### EXAMPLE 3

A panicky horse was tethered with three loops, and with the device applied loosely. It is a common occurrence with some horses that they may be startled and panic, and pull back violently on their tether rope. If the tether rope is tied with a knot, they meet resistance, and can panic even further. Horses that pull back frequently may sometimes anticipate the feeling of being trapped, which increases their anxiety and escalates their panic. In some cases, they will pull back so forcefully that the rope or halter will break, and the horse may flip over or fall, causing serious injury. In this example, the device was secured such that any willful attempt by the horse to pull back would not meet the Threshold Slip Load, however the higher force that occurs due to panic would exceed the Threshold Slip Load. When the horse did panic, the device slowly yielded more rope, allowing the horse to rear. As more rope fed through, the horse became aware that it was not trapped (as it had expected to be), and its panic subsided, and it stood down. At this point, an additional three feet of rope had fed through the device, however the horse was still securely tethered. The attendant shortened the tether distance, and reapplied the device. Each time the horse panicked, it found that it was not trapped, and could pull enough rope through to relieve its panic. Over time, the horse became more comfortable with being tied, and the occurrences of panic became rare.

### EXAMPLE 4

An unbroken horse was tethered with three loops, and with the device applied tightly. Under these conditions, the horse could not physically exceed the Threshold Slip Load. For this reason, an attendant remained in close proximity, ready to release the device manually if an emergency situation arose. The horse struggled to pull free, and continued to struggle until it learned that it could not pull free. With time, the device was applied less tightly, until the unbroken horse learned to be tethered.

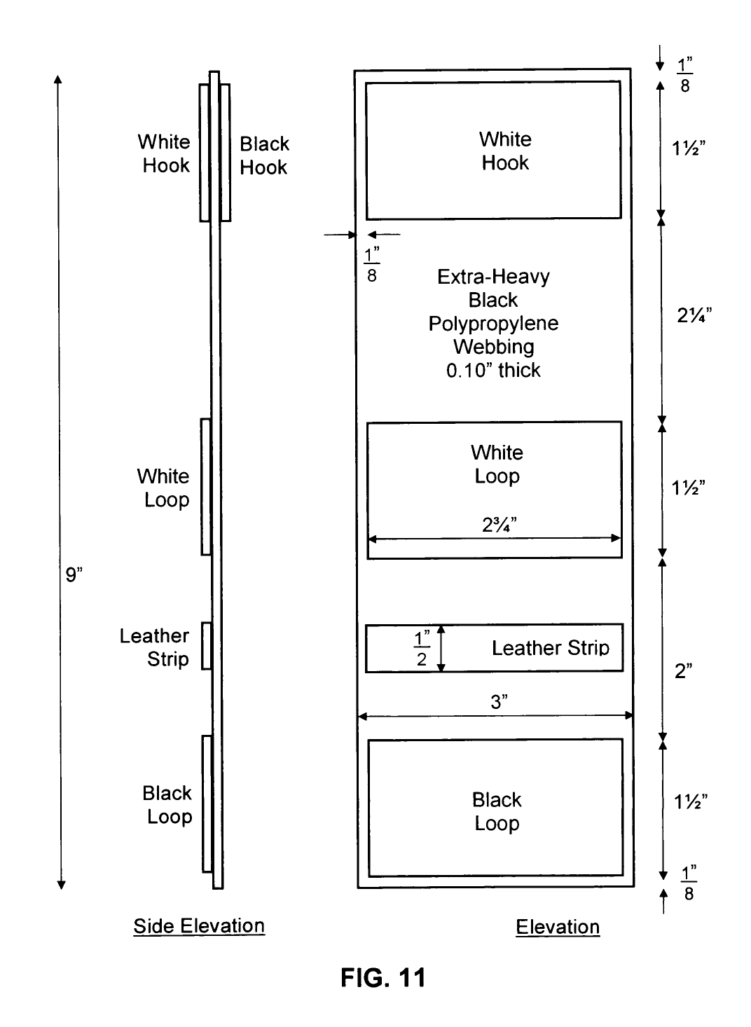

FIG. 11 shows a dimensioned orthographic drawing of the preferred embodiment that was shown schematically in FIGS. 5 through 10. The basic design is a 9-inch by 3-inch strap with hook-and-loop fasteners of size 1.5 inches by 2.75 inches. In this exemplary design, the strap is made of woven polypropylene webbing with a thickness of approximately 0.1 inches. The hook-and-loop materials are made of a generic brand similar to Velcro. The leather strip is made of suede leather of thickness 0.05 inches. The hook-and-loop fasteners are color coded for ease of use. The white pair is fastened around the load end of the lead rope in the first step, and the black pair are fastened around the loose end or the rope in the second step.

Many variations on the design in FIG. 11 have been tested. Best results have been obtained with a strap width between 1 inch and 6 inches, with superior results between 2 inches and 4 inches.

Best results have been obtained with a hook-and-loop area of between 1 square inch, and 10 square inches, with superior results between 3 square inches and 6 square inches. If the hook-and-loop area is too large, the device is too difficult to remove under emergency conditions, and may not release when the loose end of the rope is pulled. If the hook-and-loop area is too small, the device comes off too easily, and can work loose or be removed by the horse.

In the preferred embodiment, the region where the hook-and-loop fasteners are aligned represents a spacer region, keeping a fixed distance between the two ropes. Best results have been obtained with a spacer distance (being the separation of the ropes) between 0 inches and 6 inches, with superior results between 1 inch and 3 inches. This is based on the most common hitching rail diameter of approximately 3 to 4 inches.

These optimizations are incorporated into the design in FIG. 11. The strap width in this exemplary design is 3 inches. The spacer width in this exemplary design is 1½ to 2 inches, depending on how tightly the device is secured. The hook-and-loop area in this exemplary design is 4.1 square inches. A fairly wide tolerance in the design of FIG. 11 provides near-optimal performance.

Various designs have been tested using different strap materials, including heavy cotton fabric, canvas, reinforced marine vinyl, leather in several thicknesses, cotton webbing, polypropylene webbing, and double-sided hook-and-loop (where the hook-and-loop materials are glued back-to-back to produce a strap).

Best results were obtained with relatively non-elastic materials.

Best results were obtained with strap materials between 0.03 inches and 0.4 inches in thickness, with superior results between 0.05 and 0.15 inches. Thinner materials “scrunched” up when the ropes slipped through the device. Thicker materials were difficult to fasten and unfasten.

Leather showed good results, but might not stand up well to wet conditions, and may entice some horses to chew on the device. Polypropylene webbing of 0.1 inch thickness met all material requirements.

The design shown in FIG. 11 requires the hook-and-loop fasteners and leather strip, to be attached to webbing. Techniques such as sewing, gluing, and sonic welding are suitable for attaching the various components to the strap.

We claim:

1. A device for tethering an animal or object to a tie-rail or other fixed member by means of a tether rope or leash which is connected to the animal or object, and which is looped one or more times over the tie-rail or member, such device comprising:
a first removable friction cuff providing a means of attaching the device to the load end of the tether; and
a second removable friction cuff providing a means of also attaching the device to the loose end of the tether, thereby securing the loose end of the tether to the load end of the tether.

2. The device in claim 1 where one or both of the first and second friction cuffs are attached by removeable hook-and-loop fasteners.

3. The device in claim 1 where one or both of the first and second friction cuffs are attached by removable snap fasteners or other similar fasteners.

4. The device in claim 1 where the friction cuff is made of a strap of polymer-fiber webbing, heavy fabric, leather or a similar strong flexible material.

5. The device in claim 4 where the strap material is chosen or modified to control the frictional force imparted to the tether rope when a load is applied to the tether rope.

6. The device in claim 4 where the strap has a width of between 1 inch and 6 inches, and preferably between 2 inches and 4 inches.

7. The device in claim 4 where the strap has a thickness of between 0.03 inch and 0.4 inches, and preferably between 0.05 inches and 0.15 inches.

8. A method of tethering an animal or object to a tie-rail or other fixed member by means of a tether rope or tether strap which is connected to the animal or object, comprising:
looping the tether rope one, two, three or more times over the tie-rail or member;
attaching a device to the load end of the tether rope, at some point between the animal or object being tethered and the tie-rail or member, by means of a first removable fastener; and
attaching the same device to the loose end of the tether rope by means of a second removable fastener, thereby securing the loose end of the tether rope to the load end of the tether rope in a removable fashion.

9. The method in claim 8 where the steps of (1) looping the tether rope over the tie-rail, (2) fastening the first fastener, and (3) fastening the second fastener, are performed in any practical order.

10. The method in claim 8 where the rope is only looped once over the tie-rail and the device is fastened relatively loosely to the tether rope so as to impart reduced friction onto the tether rope, resulting in easy slippage of the rope, thereby allowing the tether-rope to pull through the device and over the tie-rail, thereby feeding through more tether rope and lengthening the tether distance in response to modest pressure or load from the animal or object being tethered.

11. The method in claim 8 where the rope is looped one or two or more times over the tie-rail and the device is fastened relatively tightly to the tether rope so as to impart increased friction onto the tether rope, resulting in restricted slippage of the rope, thereby limiting the ability of the tether-rope to pull through the device and over the tie-rail, thereby only feeding through more tether rope and lengthening the tether distance in response to considerable pressure or load from the animal or object being tethered.

12. The method in claim 8 where the rope is looped two or three or more times over the tie-rail and the device is fastened relatively tightly to the tether rope so as to impart sufficient friction onto the tether rope to result in no significant slippage of the rope, even in response to extreme pressure or load from the animal or object being tethered.

13. A method of un-tethering an animal or object that has been tethered to a tie-rail or other fixed member by the method in claim 8, comprising the removal of either or both of the first and second fasteners, and optionally un-looping the tether rope from the tie-rail, thereby allowing the tether rope to pull free.

14. The method of claim 13 where the first or second fastener is unfastened manually by an operator.

15. The method of claim 13 where the first or second fastener is unfastened manually by an operator by means of pulling the loose end of the tether rope in such a direction and with such force that the fastener breaks free, said fastener having been designed and applied in a fashion to provide such utility.

16. The method of claim 13 where the first or second fastener is unfastened as a result of moderate or extreme force applied to the load end of the tether rope by the animal or object being tethered, said fastener having been designed and applied in a fashion to provide such utility.
